(19) United States
(12) Patent Application Publication
(10) Pub. No.: US 2022/0320521 A1
(43) Pub. Date: Oct. 6, 2022

(54) NEGATIVE ELECTRODE PLATE, LITHIUM-ION SECONDARY BATTERY, AND MANUFACTURING METHOD FOR NEGATIVE ELECTRODE PLATE

(71) Applicant: Prime Planet Energy & Solutions, Inc., Tokyo (JP)

(72) Inventors: Tomoyuki UEZONO, Okazaki-shi (JP); Sokichi OKUBO, Okazaki-shi (JP); Momoka MIYAJIMA, Toyota-shi (JP)

(21) Appl. No.: 17/687,693

(22) Filed: Mar. 7, 2022

(30) Foreign Application Priority Data
Mar. 30, 2021 (JP) 2021-056815

(51) Int. Cl. H01M 4/66; H01M 10/0525; H01M 4/62; H01M 4/04

(52) U.S. Cl. CPC H01M 4/663; H01M 10/0525; H01M 4/622; H01M 4/0435; H01M 2004/027

(57) ABSTRACT

A negative electrode plate is provided with a current collecting foil and an active material layer. The active material layer formed on the current collecting foil includes flake graphite particles and a binder resin in a manner that the flake graphite particles are bound to one another and the flake graphite particles and the current collecting foil are bound by the heat-melted binder resin, and a peak intensity ratio by an XRD analysis of the active material layer is 130 or less.

### CROSS-REFERENCE TO RELATED APPLICATIONS

This application is based upon and claims the benefit of priority from the prior Japanese Patent Application No. 2021-056815, filed Mar. 30, 2021 the entire contents of which are incorporated herein by reference.

### BACKGROUND

### Technical Field

The present disclosure relates to a negative electrode plate provided with an active material layer including flake graphite particles and a binder resin on a current collecting foil, a lithium-ion secondary battery provided with this negative electrode plate, and a manufacturing method for this negative electrode plate.

### Background Art

As a negative electrode plate used for a lithium-ion secondary battery (hereinafter, simply referred as a “battery”), there has been known a negative electrode plate formed in a manner that an active material layer including flake graphite particles (negative active material particles) and a binder resin is formed on a current collecting foil. This type of negative electrode plate is manufactured by the following method, for example. Specifically, the flake graphite particles, binder particles formed of the binder resin, and a disperse medium are mixed such that the flake graphite particles are dispersed in the disperse medium and the binder particles are dissolved in the disperse medium, and thereby an active material paste is obtained in advance. Then, this active material paste is applied on the current collecting foil to form an undried active material layer on the current collecting foil. Thereafter, hot air is blown to the undried active material layer for heating and drying to form an active material layer. In this manner, the binder resin that has been dissolved in the disperse medium is precipitated and the precipitated binder resin binds the flake graphite particles one another and binds the flake graphite particles with the current collecting foil. In the following explanation, this manufacturing method for the negative electrode plate is referred as a “conventional method.” Herein, as a conventional technique related to this conventional method, JP2020-087569A has been known, for example.

### SUMMARY

### Problems to be Solved

However, in the above-mentioned conventional method, the active material paste including the disperse medium is used, and accordingly, there is needed a process of heating and drying the undried active material layer to remove the disperse medium. This leads to lowering in productivity of a negative electrode plate and the negative electrode plate could be expensive.

Most of the flake graphite particles are of a flat shape having a pair of main faces (basal faces) and an edge face connecting the basal faces and being almost orthogonal to the basal faces, respectively. In a battery, lithium ions are inserted in the particles from outside of the particles mainly through the edge faces of the flake graphite particles and released out of the particles from inside of the particles. Accordingly, the lithium ions are easy to be smoothly inserted into the active material layer from the outside and easy to be released out of the active material layer when more and more flake graphite particles are placed in the active material layer in a posture that each of the edge faces is raised to face a surface of the active material layer and less and less flake graphite particles are placed in a posture that each of the basal faces is laid sideways to face the surface of the active material layer. Therefore, an internal resistance of a battery can be lowered by manufacturing a battery using a negative electrode plate having the above-mentioned active material layer.

However, in the above-mentioned conventional method, most of the flake graphite particles are placed in the active material layer in a posture that each of the flake graphite particles is laid sideways with the basal faces facing the surface of the active material layer. When the active material paste is to be applied on the current collecting foil, the flake graphite particles tend to be placed in the posture that they are laid sideways in a manner that a pair of the basal faces are arranged in parallel with a main surface of the current collecting foil. Further, when the active material paste is to be applied, even if the flake graphite particles are placed to be raised, they could be fallen down thereafter by blowing of hot air, and thus the flake graphite particles are considered to be easily laid sideways. In the thus formed active material layer, the lithium ions are hard to be inserted in the active material layer and hard to be released out of the active material layer. Accordingly, when a battery is manufactured with this negative electrode plate, an internal resistance of the battery could be increased.

Thus, the negative electrode plate manufactured by the above-mentioned conventional method has a problem that the battery could be expensive and the internal resistance could be increased.

The present disclosure has been made in view of the above circumstances and has a purpose of providing a negative electrode plate which is inexpensive and can lower the internal resistance, a lithium-ion secondary battery provided with this negative electrode plate, and a manufacturing method for this negative electrode plate.

### Means for Solving the Problem

One aspect of the present disclosure for solving the above problem is a negative electrode plate comprising: a current collecting foil; and an active material layer formed on the current collecting foil and including flake graphite particles and a binder resin, the flake graphite particles being bound to one another and the flake graphite particles and the current collecting foil being bound by the heat-melted binder resin, and a peak intensity ratio obtained by an XRD analysis being set to be 130 or less.

The above-mentioned negative electrode plate is formed by binding the flake graphite particles to one another or binding the flake graphite particles with the current collecting foil constituting the active material layer by use of the heat-melted binder resin. This active material layer can be formed in a dried state by heat-melting the binder particles made of the binder resin without using the active material paste which includes the disperse medium like the above-mentioned conventional method. Accordingly, there is no need to perform a heating and drying process for removing the disperse medium, and thus the productivity of the negative electrode can be enhanced and the negative electrode plate can be formed inexpensively as compared with the conventional method.

Further, the above-mentioned active material layer of the negative electrode plate has the peak intensity ratio obtained by the XRD analysis of 130 or less. The “peak intensity ratio” is a value obtained by the following method. Specifically, the active material layer of the negative electrode plate is measured by an X-ray diffraction (XRD) measurement by use of CuKα ray. A peak indicating an existence of a (004) plane appears around a diffraction angle 2θ=54.6 degree and a peak indicating an existence of a (110) plane appears around a diffraction angle 2θ=77.5 degree. The peak intensity ratio (=P(004)/P(110)) can be calculated by dividing the peak intensity (the number of counts) P(004) of the (004) plane by the peak intensity (the number of counts) P(110) of the (110) plane.

It has been confirmed that the larger the peak intensity P(004) of the (004) plane is, the more flake graphite particles are laid sideways with the basal faces facing the surface of the active material layer. On the other hand, the larger the peak intensity P(110) of the (110) plane is, the more flake graphite particles are raised with the edge faces facing the surface of the active material layer. The active material layer of the negative electrode plate manufactured by the above-mentioned conventional method has, for example, the peak intensity ratio exceeding 180 as mentioned below.

To address this, the above-mentioned active material layer of the negative electrode plate has the peak intensity ratio equal to or less than 130, and thus, as compared with the active material layer of the negative electrode plate obtained by the conventional method, there are less flake graphite particles laid sideways with the basal faces facing the surface of the active material layer and there are more flake graphite particles raised with the edge faces facing the surface of the active material layer. In the thus formed active material layer, the lithium ions are easy to be inserted in the active material layer and easy to be released out of the active material layer. Therefore, manufacturing a battery by use of the negative electrode plate having this active material layer can achieve lowering in the internal resistance. The above-mentioned negative electrode plate can be inexpensive and can achieve lowering in the internal resistance of the battery.

Herein, the “flake graphite particles” are defined as graphite particles each having an aspect ratio (d/t) of a maximum diameter d of the flake graphite particle to a thickness t (a thickness of a particle in a direction orthogonal to the basal face) of the flake graphite particle to be 5 or more. This aspect ratio (d/t) is obtained in a manner that the respective graphite particles are magnified and observed by a scanning electron microscope to measure the aspect ratio (d/t) of the respective graphite particles and an average value of the aspect ratio (d/t) of the graphite particles are calculated.

Another aspect of the present disclosure is a lithium-ion secondary battery comprising the above-mentioned negative electrode plate.

The above-mentioned lithium-ion secondary battery includes the above-mentioned negative electrode plate, and thus the battery can be inexpensive and can achieve lowering in the internal resistance.

Further, another aspect of the present disclosure is a manufacturing method for a negative electrode plate comprising: a current collecting foil; and an active material layer formed on the current collecting foil and including flake graphite particles and a binder resin, the flake graphite particles being bound to one another and the flake graphite particles and the current collecting foil being bound by the heat-melted binder resin, and a peak intensity ratio obtained by an XRD analysis being set to be 130 or less, wherein the manufacturing method includes: uncompressed layer forming of depositing composite active material particles, in which binder particles made of the binder resin are attached to the flake graphite particles, on the current collecting foil to form an uncompressed active material layer which has not yet been compressed; and pressing of heating and pressing the uncompressed active material layer and the current collecting foil so that the flake graphite particles are bound to one another and the flake graphite particles and the current collecting foil are bound by the heat-melted binder resin and the flake graphite particles are oriented at the peak intensity ratio of 130 or less to form the active material layer.

The above-mentioned manufacturing method for the negative electrode plate includes the uncompressed layer forming and the pressing, and thus the active material layer can be formed in a dried state without using an active material paste. Accordingly, a heating and drying process for removing a disperse medium is unnecessary, and thus as compared with the above-mentioned conventional method, the productivity of the negative electrode plate can be enhanced and the negative electrode plate can be manufactured inexpensively.

Further, according to the above-mentioned manufacturing method, the active material layer is formed with the peak intensity ratio obtained by the XRD analysis of 130 or less. In this active material layer, as mentioned above, the lithium ions are easy to be inserted in the active material layer and easy to be released out of the active material layer as compared with the active material layer of the negative electrode plate which is obtained by the conventional method. Therefore, manufacturing the battery by use of the negative electrode plate having this active material layer can achieve lowering in the internal resistance of the battery. According to the above-mentioned manufacturing method, the negative electrode plate can be manufactured inexpensively with lowering the internal resistance.

Further, in the above manufacturing method for the negative electrode plate, preferably, the uncompressed layer forming includes: supplying the composite active material particles to a film-forming region; and electrostatic depositing of flying the composite active material particles to the current collecting foil by an electrostatic force in the film-forming region and depositing the composite active material particles on the current collecting foil to form the uncompressed active material layer.

In the uncompressed layer forming in the above-mentioned manufacturing method for the negative electrode plate, the composite active material particles are supplied to the film-forming region (the supplying) and the composite active material particles are deposited on the current collecting foil by the electrostatic force to form the uncompressed active material layer (the electrostatic depositing). In this manner, the uncompressed active material layer can be formed easily.

As a method for supplying the composite active material particles to the film-forming region in the supplying, for example, there is a method of forming composite carrier particles by electrostatically adsorbing the composite active material particles to magnetic carrier particles and supplying the composite carrier particles to the film-forming region so that the composite active material particles are supplied to the film-forming region. Further, there may be another method of supplying the composite active material particles to the film-forming region by placing the composite active material particles in a layered manner on a roll or a belt and supplying the composite active material particles to the film-forming region by a movement of the roll or the belt.

Further, in the above-mentioned manufacturing method for the negative electrode plate, preferably, the uncompressed layer forming further includes magnetic adsorbing of magnetically adsorbing the composite carrier particles, in which the composite active material particles have been electrostatically adsorbed to the magnetic carrier particles, to the roll surface of the magnetic roll, and the supplying is carrier supplying of supplying the composite carrier particles which have been magnetically adsorbed to the roll surface to the film-forming region by rotation of the magnetic roll, and the electrostatic depositing is to fly the composite active material particles of the composite carrier particles to the current collecting foil in the film-forming region.

In the above-mentioned manufacturing method for the negative electrode plate, the uncompressed film forming includes the above-mentioned magnetic adsorbing and the carrier supplying to supply the composite active material particles to the film-forming region by use of the magnetic carrier particles and the magnetic roll. This method achieves easy formation of the uncompressed active material layer.

### BRIEF DESCRIPTION OF THE DRAWINGS

FIG. 1 is a perspective view of a battery in an embodiment;

FIG. 2 is a perspective view of a negative electrode plate in the embodiment;

FIG. 3 is a schematic sectional view of a first active material layer of the negative electrode plate in the embodiment;

FIG. 4 is a flowchart of a manufacturing method for the negative electrode plate in the embodiment;

FIG. 5 is an explanatory view of an active material layer forming apparatus in the embodiment;

FIG. 6 is an explanatory view schematically explaining a state in which composite carrier particles are magnetically adsorbed to a roll surface on a downward side of a magnetic roll and the composite carrier particles on the roll surface are moved upward by rotation of the magnetic roll in the embodiment;

FIG. 7 is an explanatory view schematically explaining a state in which the composite active material particles of the composite carrier particles are flown off to a current collecting foil in a film-forming region to deposit the composite active material particles on the current collecting foil; and

FIG. 8 is a graph showing internal resistance ratio of batteries according to examples 1 to 4 and a comparative example.

### DETAILED DESCRIPTION OF THE EXEMPLARY EMBODIMENTS

### Embodiment

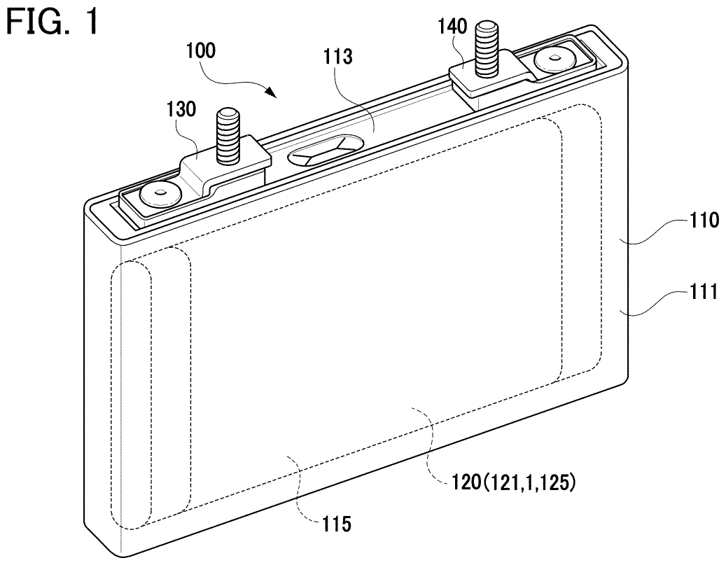

An embodiment of the present disclosure is explained below with reference to the accompanying drawings. FIG. 1 is a perspective view of a battery (a lithium-ion secondary battery) 100 according to the present embodiment. This battery 100 is a rectangular parallel-piped hermetically sealed lithium-ion secondary battery to be mounted on a vehicle such as a hybrid vehicle, a plug-in hybrid vehicle, and an electric vehicle. The battery 100 is configured with a battery case 110, an electrode body 120 and an electrolyte 115 which are accommodated in the battery case 110, and a positive electrode terminal member 130 and a negative electrode terminal member 140 which are supported by the battery case 110, and others.

Among these components, the battery case 110 is made of aluminum of a rectangular parallel-piped box-like shape, and is configured with a case body member 111 of a bottomed rectangular cylindrical shape with only an upper side opening and a case lid member 113 of a rectangular plate-like shape that is welded to close the opening of the case body member 111. To the case lid member 113, the positive electrode terminal member 130 and the negative electrode terminal member 140 are each fixedly attached in an electrically insulated state.

The electrode body 120 of a flat shape is placed fallen sideways and accommodated in the battery case 110. This electrode body 120 is formed in a manner that a strip-shaped positive electrode plate 121 and a strip-shaped negative electrode plate 1 are overlapped each other with a pair of strip-shaped separators 125 held therebetween and flat-wound around an axis.

The positive electrode plate 121 includes a current collecting foil made of a strip-shaped aluminum foil and active material layers formed on both main surfaces of the current collecting foil. These active material layers are each configured with positive active material particles that can occlude and release lithium ions, conductive particles, and a binder resin. In the present embodiment, the positive active material particles are lithium nickel-manganese-cobalt-oxide particles, the conductive particles are acetylene black (AB) particles, and the binder resin is polyvinylidene fluoride (PVDF).

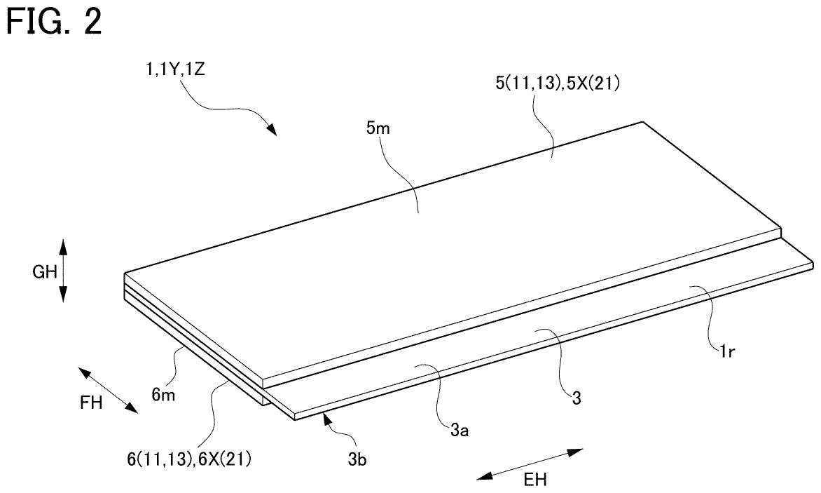

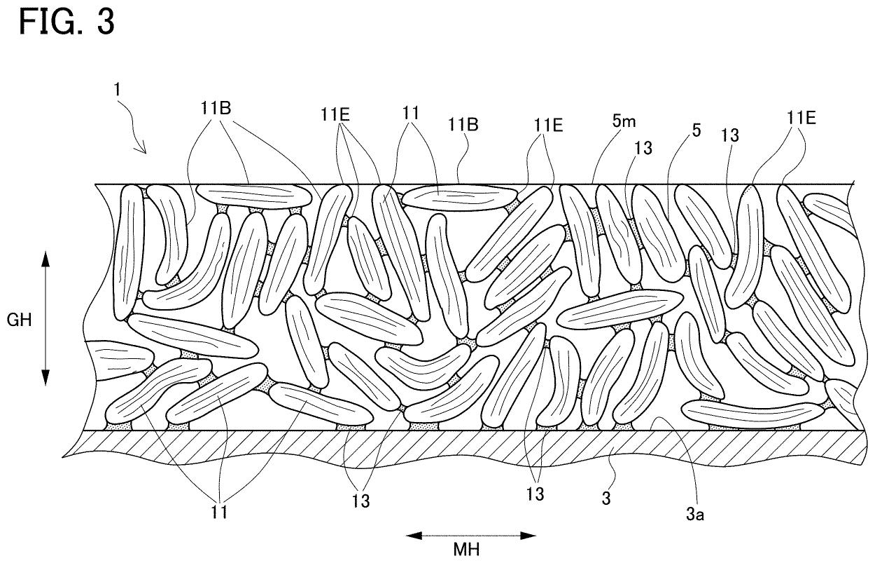

Next, the negative electrode plate 1 according to the present embodiment is explained. FIG. 2 shows a perspective view of the negative electrode plate 1 and FIG. 3 shows a schematic sectional view of a first active material layer 5 of the negative electrode plate 1. In the following explanation, a longitudinal direction EH, a width direction FH, and a thickness direction GH of the negative electrode plate 1 are each defined as directions indicated in FIG. 2 and FIG. 3. This negative electrode plate 1 is of a strip shape extending in the longitudinal direction EH and includes a current collecting foil 3 made of a copper foil with a thickness of 8 μm. A first main surface 3a of this current collecting foil 3 is formed on one side in the width direction FH (an upper left side in FIG. 2) extending in the longitudinal direction EH with the first active material layer 5 (hereinafter, simply referred as an “active material layer 5”) of a strip-like shape with a thickness of 60 μm. Further, a second main surface 3b of the current collecting foil 3 is formed on the one side in the width direction FH extending in the longitudinal direction EH with a second active material layer 6 (hereinafter, simply referred as an “active material layer 6”) of a strip-like shape with a thickness of 60 μm. The other side of the negative electrode plate 1 in the width direction FH (a lower right side in FIG. 2) is an exposed portion 1r in which no active material layers 5 and 6 exist and the current collecting foil 3 is exposed in the thickness direction GH.

The active material layers 5 and 6 are each configured with flake graphite particles 11 as negative active material particles through which lithium ions can be occluded and released and a binder resin 13. In the present embodiment, the binder resin 13 is PVDF. A weight ratio of the flake graphite particles 11 and the binder resin 13 is defined as the active material particles:the binder resin=95:5. The flake graphite particles 11 are bound to one another and the flake graphite particles 11 and the current collecting foil 3 are bound by the heat-melted binder resin 13 to configure the active material particles 5 and 6.

Further, each of these active material layers 5 and 6 has a peak intensity ratio Rp of 130 or less that is obtained by an XRD analysis, specifically, the peak intensity ratio Rp is set as Rp=23. The peak intensity ratio Rp is obtained by the above-mentioned method by performing the XRD analysis with a sample-horizontal type of Multipurpose X-Ray Diffractometer Ultima IV of Rigaku Corporation.

The respective flake graphite particles 11 configuring the active material layers 5 and 6 are placed mostly randomly. To be specific, the flake graphite particles 11 are included in the active material layers 5 and 6 at random in a manner that some edge faces 11E face the thickness direction GH of the active material layers 5 and 6 with the basal faces 11B facing a plane surface direction MH along surfaces 5m and 6m of the active material layers 5 and 6 (in a direction orthogonal to the thickness direction GH), some basal faces 11B face the thickness direction GH of the active material layers 5 and 6 with the edge faces 11E facing the plane surface direction MH, and some edge faces 11E and some basal faces 11B both obliquely face the thickness direction GH and the plane surface direction MH.

The above-mentioned negative electrode plate 1 is configured such that the flake graphite particles 11 are bound to one another and the flake graphite particles 11 and the current collecting foil 3 are bound by the heat-melted binder resin 13 to constitute the active material layers 5 and 6. As explained below, the thus configured active material layers 5 and 6 can be formed by heat-melting binder particles 13P formed of the binder resin 13 in a dried state without using an active material paste including a disperse medium as the conventional method. Accordingly, a heating and drying process for removing the disperse medium is unnecessary, and thus as compared with the conventional method, productivity of the negative electrode plate can be enhanced and the negative electrode plate 1 can be inexpensive. Therefore, the battery 100 utilizing this negative electrode plate 1 can also be inexpensive.

Further, the active material layers 5 and 6 of the negative electrode plate 1 has the peak intensity ratio Rp of 130 or less, and thus as compared with an active material layer of a negative electrode plate obtained by the conventional method, there are less flake graphite particles 11 laid sideways with the basal faces 11B facing the surfaces 5m and 6m of the active material layers 5 and 6, and there are more flake graphite particles 11 raised with the edge faces 11E facing the surfaces 5m and 6m of the active material layers 5 and 6. The thus placed active material layers 5 and 6 are easy to have the lithium ions inserted and released, and accordingly, the battery 100 using the negative electrode plate 1 having these active material layers 5 and 6 can achieve lowering in the internal resistance R as mentioned below.

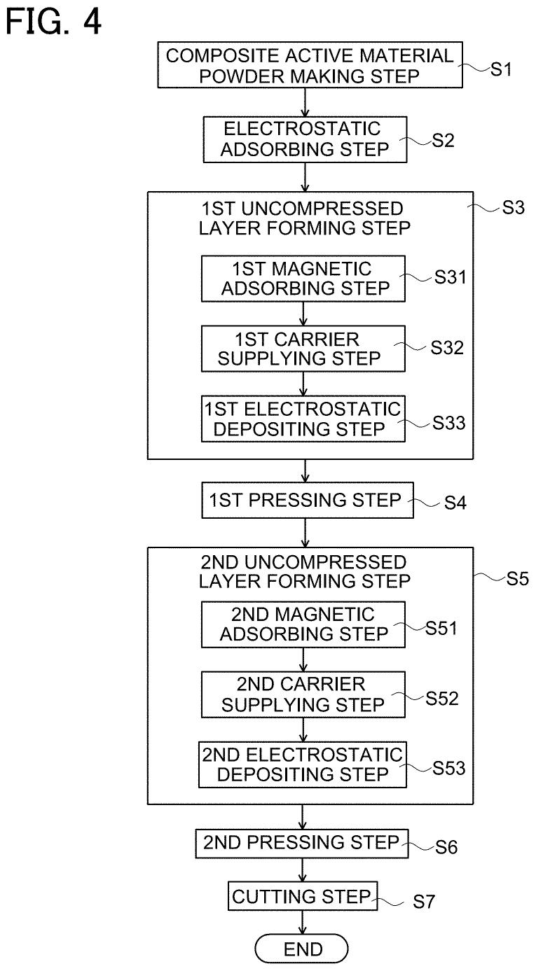

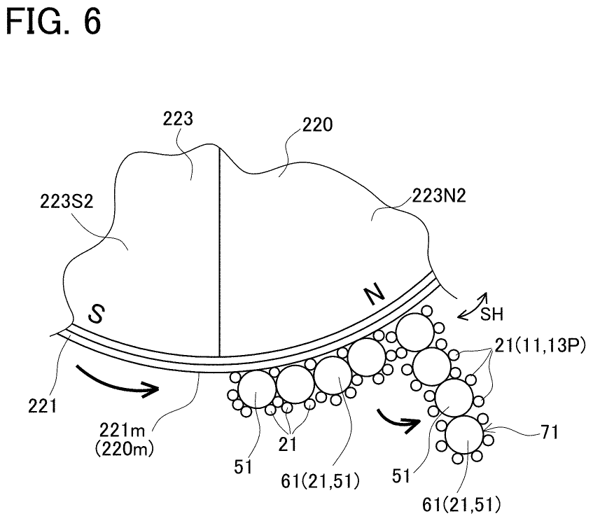

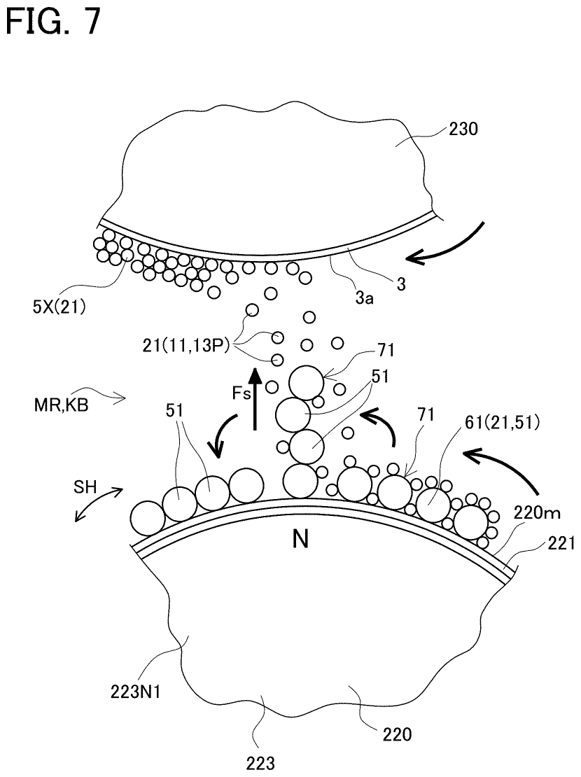

Next, a manufacturing method for the above-mentioned negative electrode plate 1 is explained (see FIGS. 4 to 7). Firstly, in a “composite active material powder making step S1” (see FIG. 4), a composite active material powder 22 is fabricated from composite active material particles 21 which is an assembly of binder particles 13P made of the binder resin 13 attached to the flake graphite particles 11. Specifically, there are prepared a graphite powder 12 in which the flake graphite particles 11 are assembled and a binder powder 14 in which the binder particles 13P (PVDF particles in the present embodiment) are assembled. The graphite powder 12 and the binder powder 14 are put in a mixer (MP Mixer of Nippon Coke & Engineering Co., Ltd.) at a weight ratio of the graphite powder:the binder powder=95:5, and then agitated and mixed for 2 minutes at 4500 rpm. Thus, the composite active material powder 22 is made with a grain size D50 (a median diameter) of about 10 μm made of the composite active material particles 21 in which a plurality of the binder particles 13P are attached to the respective flake graphite particles 11. This composite active material powder 22 does not include a disperse medium (a solid fraction ratio NV is 100 wt %).

Subsequently, in an “electrostatic adsorbing step S2” (see FIG. 4), the above-mentioned composite active material powder 22 and a magnetic carrier powder 52, in which magnetic carrier particles 51 are assembled, are mixed, and thus a composite carrier powder 62 made of composite carrier particles 61 in which the composite active material particles 21 are electrostatically adsorbed to the magnetic carrier particles 51 is obtained. In the present embodiment, as the magnetic carrier powder 52, MF96-100 (with the grain size D50 (the median diameter) of about 100 μm) of Powdertech Co., Ltd. is used. In this electrostatic adsorbing step S2, the composite active material powder 22 and the magnetic carrier powder 52 are put in a polyethylene (PE) container at a volume ratio VR (the composite active material powder/the magnetic carrier powder)=0.4, and then this polypropylene container is placed on a pot-mill rotating table to mix the composite active material powder 22 and the magnetic carrier powder 52 for 90 minutes at 105 rpm. In this manner, the composite carrier powder 62 made of the composite carrier particles 61 in which the respective composite active material particles 21 are electrostatically adsorbed to each of the magnetic carrier particles 51 is obtained.

The above-mentioned volume ratio VR is preferably in a range of 0.2 to 0.6 even though an explanation for a detailed study result is omitted. When this volume ratio VR is less than 0.2, the composite active material powder 22 is too little relative to the magnetic carrier powder 52, and this causes shortage in the amount of the composite active material particles 21 flying toward the current collecting foil 3 in a first uncompressed layer forming step S3 and a second uncompressed layer forming step S5 explained below, and thereby weight amounts of a first uncompressed active material layer 5X and a second uncompressed active material layer 6X are lessened. On the other hand, when the volume ratio VR is larger than 0.6, the composite active material powder 22 becomes too much relative to the magnetic carrier powder 52, and the composite active material powder 22 and the magnetic carrier powder 52 cannot be mixed appropriately, so that the composite carrier powder 62 fails to be made appropriately. This failure in making the composite carrier powder 62 makes it difficult to form the uniform first uncompressed active material layer 5X and the uniform second uncompressed active material layer 6X in the first uncompressed layer forming step S3 and the second uncompressed layer forming step S5 explained below.

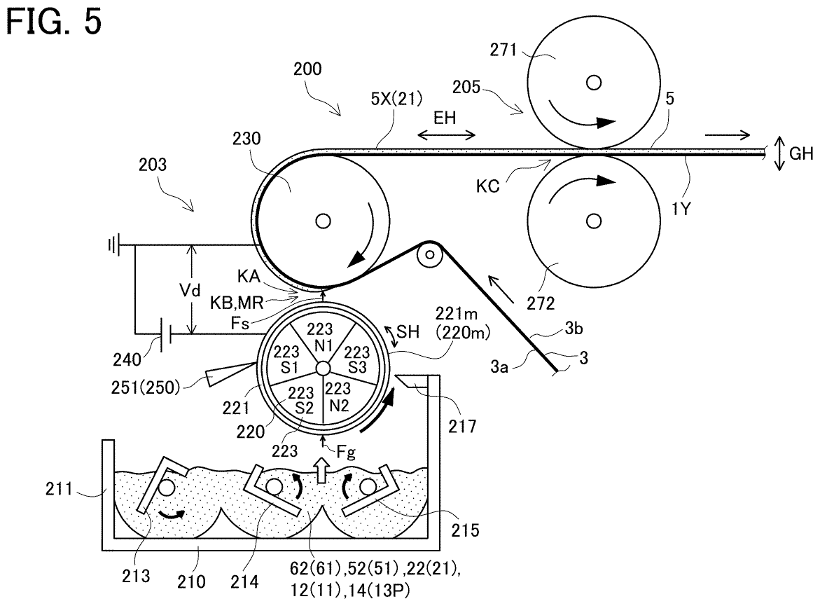

Subsequently, in the “first uncompressed layer forming step S3” (see FIG. 4), the first uncompressed active material layer 5X on which the composite active material particles 21 are deposited but uncompressed on the first main surface 3a of the current collecting foil 3 (hereinafter, simply referred as an “uncompressed active material layer 5X)” is formed. This first uncompressed layer forming step S3 and a first pressing step S4 explained below are performed serially by use of an active material layer forming apparatus 200 (see FIG. 5 to FIG. 7). The active material layer forming apparatus 200 is provided with a layer forming unit 203 forming the uncompressed active material layer 5X on the current collecting foil 3 and a pressing unit 205 forming the active material layer 5 from the uncompressed active material layer 5X by heating and pressing the uncompressed active material layer 5X and the current collecting foil 3.

The layer forming unit 203 includes a supply section 210 to supply the composite carrier powder 62 obtained in the electrostatic adsorbing step S2 to a magnetic roll 220, the magnetic roll 220 placed above the supply section 210, a backup roll 230 placed in parallel with the magnetic roll 220 to convey the current collecting foil 3 in the longitudinal direction EH, a DC power supply 240 to be electrically connected to the magnetic roll 220 and the backup roll 230, and a collecting section 250 to collect the magnetic carrier particles 51.

The supply section 210 among these sections includes a container 211 to accommodate the composite carrier powder 62 and three agitation blades 213, 214, and 215 provided in this container 211, and the supply section 210 is configured to feed the composite carrier powder 62 put in the container 211 toward the magnetic roll 220 placed above the container 211. In the container 211 of the supply section 210, on an upper right portion in FIG. 5, a squeegee 217 protruding toward a roll surface 220m of the magnetic roll 220 is provided. This squeegee 217 is to level out the composite carrier powder 62 which has been magnetically adsorbed to the roll surface 220m.

The magnetic roll 220 can adsorb the composite carrier particles 61 to the roll surface 220m by a magnetic force Fg generated on the roll surface 220m. Further, by rotation of the magnetic roll 220, the composite carrier particles 61 magnetically adsorbed to the roll surface 220m are conveyed to a clearance KB (the film-forming region MR) between the magnetic roll 220 and the current collecting foil 3. Specifically, the magnetic roll 220 includes a cylindrical metal tube 221 made of soft magnetic metal (in the present embodiment, aluminum) and a columnar inner magnet portion 223 of a five-polar structure which is placed inside the metal tube 221 coaxially with this metal tube 221.

An outer circumferential surface 221m of the metal tube 221 constitutes the roll surface 220m of the magnetic roll 220. This metal tube 221 is rotated in a counter-clockwise direction in FIG. 5 by a motor (not shown) coupled thereto.

On the other hand, the inner magnet portion 223 is fixed and not rotated. The inner magnet portion 223 is configured by circumferentially placing a plurality of magnets having their N poles on an outer circumferential side (a first magnet 223N1 and a fourth magnet 223N2) and a plurality of magnets having their S poles on the outer circumferential side (a second magnet 223S1, a third magnet 223S2, and a fifth magnet 223S3) in a circumferential direction SH. The first magnet 223N1 is placed on an upper side and the second magnet 223S1, the third magnet 223S2, the fourth magnet 223N2, and the fifth magnet 223S3 are placed in this order from the first magnet 223N1 in the counter-clockwise direction.

The backup roll 230 is placed in parallel with the magnetic roll 220 with a roll clearance KA above the magnetic roll 220, and there is provided the clearance KB (the film-forming region MR) between the current collecting foil 3 having been wound around the backup roll 230 and the magnetic roll 220. This backup roll 230 is rotated in a direction opposite to the magnetic roll 220 (in FIG. 5, in a clockwise direction) by a motor (not shown) connected thereto and comes to contact with the second main surface 3b of the current collecting foil 3 which is to be supplied to the layer forming unit 203 of the active material layer forming apparatus 200 from a lower right side in FIG. 5 so that the wound current collecting foil 3 is further conveyed in the longitudinal direction EH to the pressing unit 205 explained below.

The DC power supply 240 includes a positive electrode electrically connected to the backup roll 230 and a negative electrode electrically connected to the magnetic roll 220. Further, the backup roll 230 is grounded. By this DC power supply 240, in the present embodiment, a DC voltage Vd of Vd=−800V is applied between the magnetic roll 220 and the backup roll 230. Specifically, a potential of the magnetic roll 220 is set as −800 V with the potential of the backup roll 230 as a reference (0V). Thus, the composite active material particles 21 constituting the composite carrier particles 61 on the magnetic roll 220 is subjected to an electrostatic force Fs, and thereby the composite active material particles 21 are flown toward the current collecting foil 3 from the roll surface 220m.

The collecting section 250 is placed on a left side of the magnetic roll 220 in FIG. 5. This collecting section 250 includes a collection blade 251 protruding toward the roll surface 220m of the magnetic roll 220. This collection blade 251 is to scrape off and collect the magnetic carrier particles 51 which have been magnetically adsorbed to the roll surface 220m.

The pressing unit 205 of the active material layer forming apparatus 200 includes a pair of press-rolls 271 and 272 placed in parallel to each other with a roll clearance KC formed therebetween. These press-rolls 271 and 272 are configured to heat and press the current collecting foil 3 and the uncompressed active material layer 5X, which are to be conveyed from the layer forming unit 203, in the roll clearance KC.

Subsequently, the first uncompressed layer forming step S3 and the first pressing step S4 (see FIG. 4) performed by the above-mentioned active material layer forming apparatus 200 are explained (see FIG. 5 to FIG. 7). The first uncompressed layer forming step S3 includes a first magnetic adsorbing step S31, a first carrier supplying step (a first supplying step) S32, and a first electrostatic depositing step S33 in this order.

Firstly, in the “first magnetic adsorbing step S31,” the composite carrier particles 61 constituting the composite carrier powder 62 obtained in the electrostatic adsorbing step S2 is magnetically adsorbed to the roll surface 220m of the magnetic roll 220. Specifically, the composite carrier powder 62 is put inside the container 211 of the supply section 210, and this composite carrier powder 62 is fed to the magnetic roll 220 positioned above by the agitation blades 213, 214, and 215. Then, below the magnetic roll 220, the composite carrier particles 61 constituting the composite carrier powder 62 are magnetically adsorbed to the roll surface 220m by the magnetic force Fg generated on the roll surface 220m.

Subsequently, in the “first carrier supplying step S32,” by rotation of the magnetic roll 220 (the metal tube 221), the composite carrier particles 61 that have been magnetically adsorbed to the roll surface 220m on a lower side are moved upward and supplied to the film-forming region MR. To be more specific, the composite carrier particles 61 on the roll surface 220m form a carrier group 71 in which a plurality of the composite carrier particles 61 are tied in a row. This carrier group 71 is in a raised posture from the roll surface 220m by the N-pole of the fourth magnet 223N2 on the roll surface 220m on the lower right side. Then, when the carrier group 71 is passing through a boundary of the fourth magnet 223N2, the fifth magnet 223S3 and their vicinity, the carrier group 71 is in a laid posture along the roll surface 220m. Then, the carrier group 71 is in the raised posture raised from the roll surface 220m again by an S-pole of the fifth magnet 223S3. Thereafter, when the carrier group 71 is passing through a boundary of the fifth magnet 223S3, the first magnet 223N1 and their vicinity, the carrier group 71 is in the laid posture along the roll surface 220m again. Finally, the carrier group 71 is supplied to the film-forming region MR.

Subsequently, in the “first electrostatic depositing step S33,” in the film-forming region MR, the composite active material particles 21 of the composite carrier particles 61 are flown to the current collecting foil 3 by a DC voltage Vd which is applied between the magnetic roll 220 and the current collecting foil 3 to deposit the composite active material particles 21 on the current collecting foil 3 so that the uncompressed active material layer 5X is formed. To be more specific, the carrier group 71 on the roll surface 220m is in the raised posture raised from the roll surface 220m again by the N-pole of the first magnet 223N1 in the vicinity of the film-forming region MR, and the current collecting foil 3 is conveyed to the film-forming region MR by the backup roll 230. In the film-forming region MR, by the DC voltage Vd applied between the magnetic roll 220 and the current collecting foil 3, the composite active material particles 21 of the composite carrier particles 61 are flown to the current collecting foil 3 from the roll surface 220m to deposit the composite active material particles 21 on the current collection foil 3 so that the uncompressed active material layers 5X are serially formed. Thereafter, the magnetic carrier particles 51 remained on the roll surface 220m is moved downward by the rotation of the magnetic roll 220 and scraped off and collected by the collection blade 251 of the collecting section 250.

Subsequently, in the “first pressing step S4”, the uncompressed active material layer 5X and the current collecting foil 3 are heat-pressed to bind the flake graphite particles 11 one another and bind the flake graphite particles 11 and the current collecting foil 3 of the uncompressed active material layer 5X by the heat-melted binder resin 13. Further, the flake graphite particles 11 are oriented such that the peak intensity ratio Rp by the XRD analysis is set to be 130 or less (Rp≤130) for forming the active material layer 5.

Specifically, the current collecting foil 3 formed with the uncompressed active material layer 5X is conveyed to the pressing unit 205 from the layer forming unit 203 and heat-pressed by a pair of the press rolls 271 and 272 of the pressing section 205. A pressing condition for this heat pressing (such as a heating temperature and a pressing pressure) has been set as an appropriate pressing condition by performing preliminary tests. Thus, the binder particles 13P included in the uncompressed active material layer 5X are once melted to bind the flake graphite particles 11 one another and bind the flake graphite particles 11 and the current collecting foil 3 by the binder resin 13. In addition, the flake graphite particles 11 are oriented such that the peak intensity ratio Rp becomes 130 or less (Rp≤130). In this manner, the active material layer 5 formed of the flake graphite particles 11 and the heat-melted binder resin 13 is serially formed on the current collecting foil 3. Herein, the negative electrode plate having the active material layer 5 on the current collecting foil 3 is also referred as a “one-side negative electrode plate 1Y.”

Subsequently, the second uncompressed layer forming step S5 as similar to the above-mentioned first uncompressed layer forming step S3 is performed for the above one-side negative electrode plate 1Y to form a second uncompressed active material layer 6X (hereinafter, simply referred as the “uncompressed active material layer 6X”) on the second main surface 3b of the current collecting foil 3. Thereafter, the second pressing step S6 similar to the first pressing step S4 is performed to form the active material layer 6 from the uncompressed active material layer 6X.

Namely, in a “second magnetic adsorbing step S51” of the “second uncompressed layer forming step S5,” the composite carrier particles 61 obtained in the electrostatic adsorbing step S2 is magnetically adsorbed to the roll surface 220m of the magnetic roll 220 and the composite carrier particles 61 are supplied to the film-forming region MR by the magnetic roll 220 in a “second carrier supplying step (second supplying step) S52.” Subsequently, in a “second electrostatic depositing step S53,” in the film-forming region MR, the composite active material particles 21 of the composite carrier particles 61 are flown toward the second main surface 3b of the current collecting foil 3 so that the composite active material particles 21 are deposited on the second main surface 3b to serially form the second uncompressed active material layer 6X.

After that, in the “second pressing step S6,” the second uncompressed active material layer 6X, the current collecting foil 3, and the first active material layer 5 are heat-pressed to form the second active material layer 6 out of the second uncompressed active material layer 6X, so that a pre-cut negative electrode plate 1Z before cutting is formed. Also in this “second pressing step S6,” the second uncompressed active material layer 6X and the current collecting foil 3 are heated and pressed such that the flake graphite particles 11 are bound to one another and the flake graphite particles 11 and the current collecting foil 3 are bound by the heat-melted binder resin 13 out of the second uncompressed active material layer 6X, and simultaneously, the active material layer 6 is formed such that the flake graphite particles 11 are oriented with the peak intensity ratio Rp by the XRD analysis of 130 or less (Rp≤130).

Subsequently, in a “cutting step S7,” the above-mentioned pre-cut negative electrode plate 1Z is cut (halved) along the longitudinal direction EH of a center portion in the width direction FH. Thus, the negative electrode plate 1 shown in FIG. 2 is obtained.

As explained in detail above, the manufacturing method for the negative electrode plate 1 has the uncompressed layer forming steps S3 and S5 and the pressing steps S4 and S6, and thus the active material layers 5 and 6 can be formed in a dried state without using the active material paste including the disperse medium as the conventional method. Accordingly, there is no need to prepare a heating and drying step for removing the disperse medium, so that the productivity of the negative electrode plate 1 is enhanced and the negative electrode plate 1 can be manufactured inexpensively as compared to the conventional method.

Further, in the manufacturing method for the negative electrode plate 1, the active material layers 5 and 6 are formed at the peak intensity ratio Rp obtained by the XRD analysis of 130 or less. As compared with the active material layer of the negative electrode plate obtained by the conventional method, in these active material layers 5 and 6, the lithium ions are easy to be inserted in the active material layers 5 and 6 and easy to be released out of the active material layers 5 and 6. Therefore, manufacturing a battery 100 with using the negative electrode plate 1 having these active material layers 5 and 6 can achieve lowering in the internal resistance R of the battery as mentioned below.

As mentioned above, the manufacturing method for the negative electrode plate 1 can achieve manufacturing of the negative electrode plate 1 that is inexpensive and can lower the internal resistance R.

Further, in the present embodiment, the composite active material particles 21 are supplied to the film-forming region MR by use of the magnetic carrier particles 51 and the magnetic roll 220, and the composite active material particles 21 are deposited on the current collecting foil 3 by the electrostatic force Fs in the film-forming region MR to form the uncompressed active material layers 5X and 6X in the uncompressed layer forming steps S3 and S5. In this manner, the uncompressed active material layers 5X and 6X are easily formed.

(Test Results)

Next, results of a test performed for studying effects of the present disclosure are explained.

As an example 1, a one-side negative electrode plate 1Z having the active material layer 5 (of an electrode density 0.91 g/cm³) on the current collecting foil 3 (hereinafter, simply referred as a “negative electrode plate 1Z”) as similar to the present embodiment is prepared.

As an example 2, a negative electrode plate (of the electrode density 1.19 g/cm³) is manufactured in a manner that the negative electrode plate 1Z of the present embodiment is roll-pressed by a pair of pressing rolls with a roll gap of 40 μm to further compress the active material layer 5.

As an example 3, a negative electrode plate (of the electrode density 1.21 g/cm³) is manufactured in a manner that the negative electrode plate 1Z of the present embodiment is roll-pressed by a pair of the pressing rolls with the roll gap of 35 μm to further compress the active material layer 5.

As an example 4, a negative electrode plate (of the electrode density of 1.41 g/cm³) is manufactured in a manner that the negative electrode plate 1Z of the present embodiment is roll-pressed by a pair of the pressing rolls with the roll gap of 30 μm to further compress the active material layer 5.

On the other hand, as a comparative example, the negative electrode plate 1Z is manufactured according to the conventional method. Namely, the flake graphite particles 11, the binder particles 13P, and the disperse medium (water) are mixed such that the flake graphite particles 11 are dispersed in the disperse medium and the binder particles 13P are dissolved in the disperse medium to obtain an active material paste in advance. Then, this active material paste is applied on the current collecting foil 3 to form an undried active material layer on the current collecting foil 3, and after that, hot air is blown to this undried active material layer to heat and dry for forming the active material layer 5. Thus, the negative electrode plate 1Z (of the electrode density 0.86 g/cm³) of the comparative example is obtained.

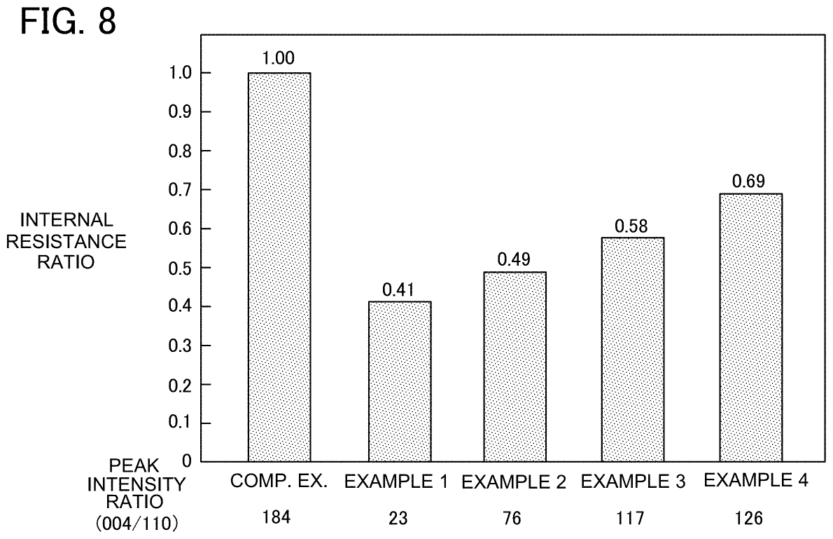

Subsequently, the active material layers 5 of the negative electrode plates 1Z of the examples 1 to 4 and the comparative example are performed with the above-mentioned XRD analysis to obtain the peak intensity ratio Rp. The analysis resulted in that each peak intensity ratio Rp is 184 in the comparative example, 23 in the example 1, 76 in the example 2, 117 in the example 3, and 126 in the example 4 (also see FIG. 8).

Subsequently, a lamination-cell-type lithium-ion battery (not shown) is fabricated from each of the negative electrode plates 1Z in the examples 1 to 4 and the comparative example. Specifically, each of the negative electrode plates 1Z faces a positive electrode plate intervened with a separator therebetween, and this negative electrode plate 1Z, the positive electrode plate, and the separator are accommodated with an electrolyte in an exterior body made of a laminated film to fabricate the respective batteries for testing.

Subsequently, the respective batteries are measured their internal resistance R. Specifically, the respective batteries are placed under an environment temperature of −10° C. and adjusted their SOC to 56% (a battery voltage of 3.70 V). After that, the batteries are discharged for 10 seconds at a constant current I of 1 C to measure the battery voltage V before and after charging and obtain a change amount ΔV of the battery voltage V. Further, the internal resistance (IV resistance) of the respective batteries is obtained by a formula R=ΔV/I. Then, with defining the internal resistance R of the battery in the comparative example as a reference (=1.00), a “battery resistance ratio” of the battery resistance R of the respective batteries in the examples 1 to 4 is calculated. The thus calculated results are shown in FIG. 8.

It is clear from a graph in FIG. 8 that, as compared with the battery of the comparative example which has the peak intensity ratio Rp of the active material layer over 130, the internal resistance ratio (the internal resistance R) becomes small in the batteries of the examples 1 to 4 each having the peak intensity ratio Rp of the active material layer 5 of 130 or less. Further, comparison of the batteries of the examples 1 to 4 one another has revealed that the smaller the peak intensity ratio Rp becomes, the lower the internal resistance ratio (the internal resistance R) becomes.

In the active material layer 5 having the small value of the peak intensity ratio Rp, there are few flake graphite particles 11 having the basal faces 11B laid sideways to face the surface 5m of the active material layer 5, and there are many flake graphite particles in a raised posture with the edge faces 11E facing the surface 5m of the active material layer 5. In the active material layer 5, the lithium ions are easy to be inserted and easy to be released. Accordingly, it is considered that the battery utilizing the negative electrode plate 1 having the active material layer 5 with less value of the peak intensity ratio Rp can achieve lowering in the internal resistance ratio (the internal resistance R).

The present disclosure has been explained in detail above with the embodiment, but the present disclosure is not limited to the present embodiment and may naturally be adopted with appropriate modifications without departing from the scope of the disclosure.

### REFERENCE SIGNS LIST

1 Negative electrode plate
3 Current collecting foil
5 First active material layer
5x First uncompressed active material layer
6 Second active material layer
6X Second uncompressed active material layer
11 Flake graphite particle
11E Edge face
11B Basal face
13 Binder resin
13P Binder particle
21 Composite active material particle
51 Magnetic carrier particle
61 Composite carrier particle
100 Battery (lithium-ion secondary battery)
120 Electrode body
200 Active material layer forming apparatus
220 Magnetic roll
220m Roller surface
230 Backup roll
240 DC power supply
MR Film-forming region
Vd DC voltage
Fg Magnetic force
Fs Electrostatic force
S1 Composite active material layer powder making step
S2 Electrostatic adsorbing step
S3 First uncompressed layer forming step
S31 First magnetic adsorbing step
S32 First carrier supplying step (first supplying step)
S33 First electrostatic depositing step
S4 First pressing step
S5 Second uncompressed layer forming step
S51 Second magnetic adsorbing step
S52 Second carrier supplying step (second supplying step)
S53 Second electrostatic depositing step
S6 Second pressing step

What is claimed is:

1. A negative electrode plate comprising:
a current collecting foil; and
an active material layer formed on the current collecting foil and including flake graphite particles and a binder resin, the flake graphite particles being bound to one another and the flake graphite particles and the current collecting foil being bound by the heat-melted binder resin, and a peak intensity ratio obtained by an XRD analysis being set to be 130 or less.

2. A lithium-ion secondary battery comprising the negative electrode plate according to claim 1.

3. A manufacturing method for a negative electrode plate, the negative electrode plate comprising:
a current collecting foil; and
an active material layer formed on the current collecting foil and including flake graphite particles and a binder resin, the flake graphite particles being bound to one another and the flake graphite particles and the current collecting foil being bound by the heat-melted binder resin, and a peak intensity ratio obtained by an XRD analysis being set to be 130 or less, wherein
the manufacturing method includes:
uncompressed layer forming of depositing composite active material particles, in which binder particles made of the binder resin are attached to the flake graphite particles, on the current collecting foil to form an uncompressed active material layer which has not yet been compressed; and
pressing of heating and pressing the uncompressed active material layer and the current collecting foil so that the flake graphite particles are bound to one another and the flake graphite particles and the current collecting foil are bound by the heat-melted binder resin and the flake graphite particles are oriented at the peak intensity ratio of 130 or less to form the active material layer.

4. The manufacturing method for the negative electrode plate according to claim 3, wherein the uncompressed layer forming includes:
supplying the composite active material particles to a film-forming region; and
electrostatic depositing of flying the composite active material particles to the current collecting foil by an electrostatic force in the film-forming region and depositing the composite active material particles on the current collecting foil to form the uncompressed active material layer.

5. The manufacturing method for the negative electrode plate according to claim 4, wherein
the uncompressed layer forming further includes magnetic adsorbing of magnetically adsorbing the composite carrier particles, in which the composite active material particles have been electrostatically adsorbed to the magnetic carrier particles, to the roll surface of the magnetic roll,
the supplying is carrier supplying of supplying the composite carrier particles which have been magnetically adsorbed to the roll surface to the film-forming region by rotation of the magnetic roll, and
the electrostatic depositing is to fly the composite active material particles of the composite carrier particles to the current collecting foil in the film-forming region.
